(19) United States
(12) Patent Application Publication
(10) Pub. No.: US 2025/0348822 A1
(43) Pub. Date: Nov. 13, 2025

(54) SYSTEMS AND METHODS WITH PREDICTIVE MODELS FOR ESTIMATING TUNING COEFFICIENTS OF A CLASSIFICATION YARD

(71) Applicant: BNSF Railway Company, Fort Worth, TX (US)

(72) Inventors: Daniel E. Pittman, Kansas City, MO (US); Michael P. Lee, Shawnee, KS (US); Charles W. Morse, Anahola, HI (US)

(73) Assignee: BNSF Railway Company, Fort Worth, TX (US)

(21) Appl. No.: 18/658,732

(22) Filed: May 8, 2024

Related U.S. Application Data
(63) Continuation-in-part of application No. 18/658,386, filed on May 8, 2024.

(51) Int. Cl. G06Q 10/0637; G06Q 10/047; G06Q 50/40

(52) U.S. Cl. CPC G06Q 10/06375; G06Q 10/047; G06Q 50/40

(57) ABSTRACT

Methods and systems providing predictive models for estimating tuning coefficients for automatically tuning operations of a classification yard. In embodiments, a set of predictions for car events at a segment or device may be generated using a current set of tuning coefficients for the segment or device. Real-world data related to the car events at the segment or device may be compiled, and a set of candidate tuning coefficients may be generated for the segment or device based on application of a predictive model to the real-world data. The segment or device may be automatically tuned based on a comparison of the set of candidate tuning coefficients and current set of tuning coefficients to the real-world data to determine which of the set of candidate tuning coefficients and the current set of tuning coefficients yields more accurate results for cuts passing the segment or device.

### CROSS-REFERENCE TO RELATED APPLICATIONS

The present application is a Continuation-in-Part of U.S. patent application Ser. No. 18/658,386, filed on May 8, 2024, the entirety of which is herein incorporated by reference for all purposes.

### TECHNICAL FIELD

The present disclosure relates generally to classification yard control systems, and more particularly to predictive models for estimating tuning coefficients for automatically tuning operations of a classification yard.

### BACKGROUND

Trains allow us to transport passengers and freight long distances for a relatively inexpensive cost. A typical train may be composed of one or more locomotive engines and one or more train cars being pulled and/or pushed by the one or more engines. The trains are assembled in a classification yard. In typical operations of a classification yard, hundreds or thousands of train cars are moved through marshalling tracks to route each of the train cars to a respectively assigned track, where the train car is coupled to its assigned train. Once the train is fully assembled, the train may leave the classification yard and travel to its destination.

A particular implementation of a classification yard is a hump yard. A hump yard is a type of classification yard that uses gravity to classify train cars into their assigned train. In a hump yard, a rolling stock train that includes the train cars to be classified is pushed up the hump section (e.g., typically an elevated area, which may include and artificial or natural a hill, mount, etc.), where, as the train cars reach the crest of the hump (e.g., the top or apex of the hump) and begin rolling past the crest into the downward release section of the hump, train cars, or group of train cars, are “cut” (e.g., decoupled or separated) from the rolling stock train by gravity and begin rolling downhill away from the crest into the release area, which typically branches out into multiple marshalling tracks (each of which may eventually lead to a destination track). The cuts then coast through the marshalling tracks of the hump yard and are routed to their assigned destination track where each cut is coupled to its assigned destination train.

In a hump yard, controlling the movement of a cut as it travels through the marshalling tracks is exceedingly important. For example, controlling the route of each cut is important to ensure that each cut is routed to the respectively assigned destination train, to avoid potential collisions between the various cuts, and/or to load-balance the use of the marshalling tracks as the cuts are released onto the marshalling tracks. Additionally, controlling the speed of each cut as it travels through the marshalling tracks, and when the cut reaches the coupling point, is very important in order to avoid accidental damage to equipment, train cars, and/or the freight itself. Furthermore, controlling the speed of cuts is also very important to ensure that the cuts maintain enough speed through their route to reach the coupling point, otherwise the cuts may stall within the marshalling tracks without making it to the destination train, which may cause operational problems and potential collisions. Moreover, ensuring that the enough separation between the various cuts is maintained as they travel through the marshalling tracks is important to avoid collisions between cuts.

Current hump yard systems use various mechanisms and/or hardware devices to control the route and/or speed of the various cuts as these various cuts travel through the marshalling tracks of the hump yard. For example, current hump yard systems may include mechanisms to regulate the speed of the hump push engine as it pushes train cars up the hump. In this manner, the speed of the hump push engine may be controlled to control the release speed of a cut. Current hump yard systems may also use hardware devices (e.g., switches that may be configured to route a cut from a source track to a target track, wheel detectors that may be configured to detect the speed and/or arrival time of a cut, retarders that may be configured to remove energy from a cut as passes through the retarders, radar devices that may be configured to detect the presence and/or speed of a cut, distance units that may be configured to detect how far a cut may be from other cuts and/or from other devices and/or points along the route from a current position, etc.) to control the route and/or speed of cuts as they are classified using the hump yard.

Many of the operations of a hump yard (e.g., to control the route and/or speed of the various cuts as the various cuts travel through the marshalling tracks of the hump yard) rely on calculations and/or predictions associated with the speed or energy of the cuts at various points of the route. For example, a predicted speed at which a cut may arrive at and/or exit a particular segment may be generated, and the prediction may rely on characteristics of the cut as well as characteristics of the segment. The characteristics of the segment may include tuning coefficients associated with the segment. In this case, the tuning coefficients may be used in an equation to calculate the amount of energy or speed that may be gained or lost (e.g., the energy or speed delta) by a cut (e.g., any cut or a cut having specific characteristics) as the cut travels through the segment. In this manner, the tuning coefficients associated with a segment may be used to predict a speed of a cut at a point in the route of the cut, the point being associated with the tuning coefficients.

However, conditions of a classification yard change with time. For example, devices may degrade, be repaired, new devices may be added, the track or tracks within a segment may become worn out, damaged, cracked, etc., the grade of a track section may change its grade, such as by normal sinking, which may cause the grade to increase and thus may cause cuts traveling through it to gain speed due to increases potential energy, prevailing weather conditions may change, etc. These changes in the conditions of a classification yard may affect the amount of energy or speed that may be gained or lost by a cut traveling through a point in the route of the cut (e.g., a segment and/or device). Put another way, the changes in the real-world conditions of the classification yard may mean that predictions associated with a point in the route of a cut made using the current tuning coefficients of the point may not accurately reflect what may happen when the cut actually travels through the point.

Current systems lack functionality to automatically adapt to the changing conditions of a classification yard, especially when it comes to the tuning of the classification yard. In current systems, even when tuning coefficients have been obtained, the tuning coefficients may not be perfectly tuned to current conditions (e.g., environmental, track, and/or cut conditions) and may not accurately predict the rolling characteristics of the cut through the particular track and thus, may not accurately predict the speed of the cut through the marshalling tracks. The inability to accurately predict the speed of a cut through the marshalling track may affect the whole system negatively. Thus, current systems are not robust enough to ensure that the tuning coefficients used for speed predictions are accurately attuned to the actual conditions of the classification yard.

### SUMMARY

The present disclosure achieves technical advantages as systems, methods, and computer-readable storage media that provide predictive models for estimating tuning coefficients for automatically tuning operations of a classification yard.

The present disclosure provides for a system integrated into a practical application with meaningful limitations as a system with functionality for estimating tuning coefficients using predictive models and for automatically tuning segments and/or devices of the classification yard based on the estimated tuning coefficients. In embodiments, the tuning coefficients for a segment or device may be used to calculate or predict the movement (e.g., speed and/or arrival time) of cuts through the segment or device. For example, in operation according to embodiments, a set of predictions for one or more car events at a segment or device may be generated using a current set of tuning coefficients for the segment or device. In embodiments, real-world data related to the one or more car events at the segment or device may be compiled, and a set of candidate tuning coefficients may be generated for the segment or device based on application of a predictive model to the compiled real-world data. Features of the present disclosure may provide functionality to automatically tune the segment or device based on a comparison of the set of candidate tuning coefficients and current set of tuning coefficients to the compiled real-world data to determine which of the set of candidate tuning coefficients and the current set of tuning coefficients yields more accurate results for cuts passing the segment or device. Predicting an accurate speed and/or an arrival time at a segment or device of a classification track is of utmost importance as any deviation from an actual speed and/or arrival time may result in catastrophic consequences. To that end, the present disclosure provides features that may enable a system to refine the tuning of a classification yard by providing a mechanism to automatically tune segments or devices based on candidate tuning coefficients generated for the segment or device. In this manner, the present disclosure provides a system with functionality that allows the system to automatically tune the tuning coefficients to real-world conditions.

The present disclosure solves the technological problem of a lack of functionality in current systems to dynamically adapt the tuning of a classification yard to changing conditions. For example, in current systems, as real-world conditions on a classification changes (e.g., a device may degrade or be repaired, a segment of the track may degrade and thus may create more friction with the cuts traveling through it, a section of a track may change its grade, such as by normal sinking, which may cause the grade to increase and thus may cause cuts traveling through it to gain speed due to increases potential energy, weather may change, etc.), the tuning coefficients used to predict the speed and/or arrival times of cuts at various points of a route throughout the marshalling tracks may not be as accurate because of the changed conditions. In these cases, predictions made using the tuning coefficients may not accurately reflect what may happen when the cut travels its route to its destination train. As such, accidents and/or other issues may happen. A system implemented in accordance with the present disclosure may be flexible and responsive to the changing conditions of the classification yard and may automatically tune the tuning coefficients to the changing conditions, which may allow for a system that is more robust than existing systems, which are unable to adapt to changing conditions. The technological solutions provided herein, and missing from conventional systems, are more than a mere application of a manual process to a computerized environment, but rather include functionality to implement a technical process to replace or supplement current manual solutions or non-existing solutions for tuning classification yards. In doing so, the present disclosure goes well beyond a mere application the manual process to a computer. Accordingly, the claims herein necessarily provide a technological solution that overcomes a technological problem.

In various embodiments, the system comprises one or more processors interconnected with a memory module, capable of executing machine-readable instructions. These instructions include, but are not limited to, the steps outlined in any flow diagram, system diagram, block diagram, and/or process diagram disclosed herein, as well as steps corresponding to any functionality detailed herein. In embodiments, the execution of these machine-readable instructions may involve initiating multiple concurrent computer processes. Each process of the concurrent computer process may be configured to handle or process a designated subset or portion of the of the machine-readable instructions. This division of tasks enables parallel processing, multi-processing, and/or multi-threading, enabling multiple operations to be conducted or executed concurrently rather than sequentially. This functionality for spawning a plurality of concurrent processes to manage separate portions of the machine-readable instructions markedly increases the overall speed of execution of the machine-readable instructions. By leveraging parallel or concurrent processing, the time required to complete a set or subset of program steps is substantially reduced (e.g., when compared to execution without concurrent or parallel processing). This efficiency gain not only accelerates the processing speed but also optimizes the use of processor resources, leading to an improved performance of the computing system. This enhancement in computational efficiency constitutes a significant technological improvement, as it enhances the functional capabilities of the processors and the system as a whole, representing a practical and tangible technological advancement. The result of this concurrent processing functionality results in an improvement in the functioning of the one or more processor and/or the computing system, and thus, represents a practical application.

In embodiments, the present disclosure includes techniques for training models (e.g., machine-learning models, artificial intelligence models, algorithmic constructs, etc.) for performing or executing a designated task or a series of tasks (e.g., one or more features of steps or tasks of processes, systems, and/or methods disclosed in the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical application that significantly enhance the functionality, reliability, and efficiency of the models developed through these processes.

In embodiments, the present disclosure includes techniques for generating a notification of an event that includes generating an alert that includes information specifying the location of a source of data associated with the event, formatting the alert into data structured according to an information format, and/or transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a system for estimating tuning coefficients for automatic tuning of operations of a classification yard. It is a further object of the disclosure to provide a method of estimating tuning coefficients for automatic tuning of operations of a classification yard, and a computer-based tool for estimating tuning coefficients for automatic tuning of operations of a classification yard. These and other objects are provided by the present disclosure, including at least the following embodiments.

In one particular embodiment, a method of estimating tuning coefficients for automatic tuning of operations of a classification yard is provided. The method includes compiling a plurality of car events associated with a first point of a route within the classification yard. In embodiments, each car event of the plurality of car events may include actual measurements associated with each car event associated with the first point and/or a respective prediction related to each car event associated with the first point. In embodiments, the respective prediction may be generated using a set of production tuning coefficients for the first point of the route. The method also includes applying a predictive model to the plurality of car events associated with the first point to generate a candidate set of tuning coefficients for the first point of the route based on the actual measurements included in each car event of the plurality of car events, generating a candidate prediction for each car event of the plurality of car events using the candidate set of tuning coefficients for the first point of the route, determining which of the set of production tuning coefficients for the first point and the candidate set of tuning coefficients for the first point yields more accurate predictions for car events at the first point, and determining to replace the set of production tuning coefficients with the candidate set of tuning coefficients in response to a determination that the candidate set of tuning coefficients yields more accurate predictions for car events at the first point than the set of production tuning coefficients.

In another embodiment, a system for estimating tuning coefficients for automatic tuning of operations of a classification yard is provided. The system comprises at least one processor and a memory operably coupled to the at least one processor and storing processor-readable code that, when executed by the at least one processor, is configured to perform operations. The operations include compiling a plurality of car events associated with a first point of a route within the classification yard. In embodiments, each car event of the plurality of car events may include actual measurements associated with each car event associated with the first point and/or a respective prediction related to each car event associated with the first point. In embodiments, the respective prediction may be generated using a set of production tuning coefficients for the first point of the route. The operations also include applying a predictive model to the plurality of car events associated with the first point to generate a candidate set of tuning coefficients for the first point of the route based on the actual measurements included in each car event of the plurality of car events, generating a candidate prediction for each car event of the plurality of car events using the candidate set of tuning coefficients for the first point of the route, determining which of the set of production tuning coefficients for the first point and the candidate set of tuning coefficients for the first point yields more accurate predictions for car events at the first point, and determining to replace the set of production tuning coefficients with the candidate set of tuning coefficients in response to a determination that the candidate set of tuning coefficients yields more accurate predictions for car events at the first point than the set of production tuning coefficients.

In yet another embodiment, a computer-based tool for estimating tuning coefficients for automatic tuning of operations of a classification yard is provided. The computer-based tool including non-transitory computer readable media having stored thereon computer code which, when executed by a processor, causes a computing device to perform operations. The operations include compiling a plurality of car events associated with a first point of a route within the classification yard. In embodiments, each car event of the plurality of car events may include actual measurements associated with each car event associated with the first point and/or a respective prediction related to each car event associated with the first point. In embodiments, the respective prediction may be generated using a set of production tuning coefficients for the first point of the route. The operations also include applying a predictive model to the plurality of car events associated with the first point to generate a candidate set of tuning coefficients for the first point of the route based on the actual measurements included in each car event of the plurality of car events, generating a candidate prediction for each car event of the plurality of car events using the candidate set of tuning coefficients for the first point of the route, determining which of the set of production tuning coefficients for the first point and the candidate set of tuning coefficients for the first point yields more accurate predictions for car events at the first point, and determining to replace the set of production tuning coefficients with the candidate set of tuning coefficients in response to a determination that the candidate set of tuning coefficients yields more accurate predictions for car events at the first point than the set of production tuning coefficients.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an exemplary system configured with capabilities and functionality for providing predictive models for estimating tuning coefficients for automatically tuning operations of a classification yard in accordance with embodiments of the present disclosure.

FIG. 2 is a block diagram illustrating an example of application of a set of linear regression models to estimate a candidate set of tuning coefficients in accordance with the embodiments of the present disclosure.

FIG. 3 shows a high-level flow diagram of operation of a system that provides predictive models for estimating tuning coefficients for automatically tuning operations of a classification yard in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

Various embodiments of the present disclosure are directed to systems and techniques that provide predictive models for estimating tuning coefficients for automatically tuning operations of a classification yard.

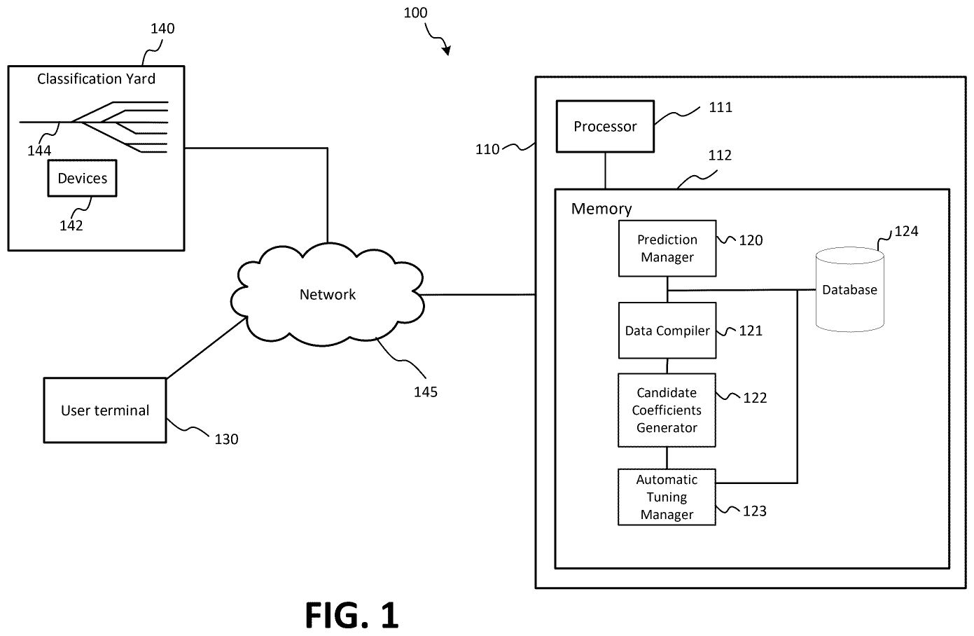

FIG. 1 is a block diagram of an exemplary system 100 configured with capabilities and functionality that provide predictive models for estimating tuning coefficients for automatically tuning operations of a classification yard in accordance with embodiments of the present disclosure. As shown in FIG. 1, system 100 may include server 110, classification yard 140, user terminal 130, and network 145. These components, and their individual components, may cooperatively operate to provide functionality in accordance with the discussion herein. For example, in operation according to embodiments, classification yard 140 may operate various components (e.g., switches, detectors, retarders, track segments, etc.) to route cuts through marshalling tracks of classification yard 140 to their designated destination tracks/trains, while ensuring that the coupling speed at the coupling point is as close to a target coupling speed as possible. In embodiments, classification yard 140 may operate to control the speed of the cuts as the cuts travel through the marshalling tracks of classification yard 140. Classification yard 140 may operate to generate predictions related to the speed of a cut through each device and/or segment along the route of the cut. The predictions may be generated based on rollability parameters associated with the segment or device, which may include environmental, track, and/or cut characteristics, as well as determinations of energy to be removed by retarders along the route, and may include calculations using tuning coefficients associated with the segment or device. Functionality of server 110 may provide predictive models for estimating tuning coefficients, where the estimated tuning coefficients may include candidate tuning coefficients that may be used to automatically tune the segment or device to current conditions.

In embodiments, functionality of server 110 may provide predictive models for estimating tuning coefficients for automatically tuning operations by generating a set of predictions for one or more car events at a first point of a route using a current set of tuning coefficients for the first point, compiling real-world data related to the one or more car events at the first point, generating a set of candidate tuning coefficients for the first point based on application of a predictive model to the compiled real-world data, and automatically tuning the first point based on a comparison of the set of candidate tuning coefficients and current set of tuning coefficients to the compiled real-world data.

It is noted that the functional blocks, and components thereof, of system 100 of embodiments of the present disclosure may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of system 100 described herein is provided for purposes of illustration, rather than by way of limitation and that functionalities described as being provided by different functional blocks may be combined into a single component or may be provided via computing resources disposed in a cloud-based environment accessible over a network, such as one of network 145.

Classification yard 140 may represent a train yard, such as a hump yard, in which train cars are routed or marshalled to a destination track to be coupled to a destination train. In a typical operation of classification yard 140, such as a hump yard, a stock train that includes train cars to be marshalled to their assigned train may be pushed by a hump push engine at a push speed along the approach section of the hump to the crest of the hump. As the train cars roll past the hump crest, gravity may begin pulling the train cars towards the bottom of the hump. In embodiments, the train cars are “cut” from the stock train and the cut is allowed to roll down the hump and is marshalled to the destination train along a route through the marshalling tracks of the hump yard. In embodiments, classification yard 140 may include functionality to plan, track, control, and report the movement of the train cars through the marshalling tracks, including the hump approach section, the hump crest, the hump release area, and multiple marshalling tracks.

As noted above, ensuring that the cut reaches the assigned destination train at the appropriate coupling speed is very important. As such, in embodiments, a cut may be tracked and controlled as the cut moves along the marshalling tracks of classification yard 140. In particular, the route and the speed of the cut from the hump to its destination track or train may be controlled using various components of classification yard 140. For example, classification yard 140 may include various components enabling classification yard 140 to track and/or control the movement of a cut through the marshalling tracks.

In embodiments, the various components enabling classification yard 140 to track and/or control the movement and/or speed of a cut through the marshalling tracks may include devices 142 and segments 144, which may include hardware devices such as switches, retarders, radars, wheel detectors, distance units, identification devices, etc. In embodiments, the cooperative operation of the various components of classification yard 140 may enable classification yard 140 to ensure that various cuts traverse the marshalling tracks and arrive at the destination coupling point at the appropriate coupling speed.

In embodiments, a switch device may be configured to route a cut from a source track to a target track. A switch may be thrown from a first position (e.g., corresponding to a first track) to a second position (e.g., corresponding to a second track) in order to route a cut passing through the switch from a source track to the second track, the second track being the target track of the cut. In this manner, switches may be used to control the route of a cut as it travels through the marshalling tracks.

A wheel detector may be configured to detect a speed of a cut by detecting the presence of a first wheel of the cut at a first time, detecting the presence of a second wheel of the cut at a second time, and determining a speed from the difference between the first and second times over the known distance between the first wheel and the second wheel. In embodiments, a radar device may be configured to detect the presence of a cut and/or to measure the speed of the cut traveling through the detection area of the radar devices. In this manner, wheel detectors and/or radars may be used to measure the speed and/or presence of cuts as the cuts move through the ump yard. In some embodiments, a device may include a combination of devices, such as a switch wheel detector, which may be configured to perform operations related to switch operations and wheel detector operations. In this manner, a switch wheel detector may be configured to route a cut to a target track and to detect the wheels of the cut (e.g., for speed measurement operations).

A retarder may be configured to slow down a cut as the cut travels through the. A retarder may be configured to apply a pressure against one or more wheels of the cut (e.g., using a braking element, such as a brake pad, etc.), which may cause the cut to slow down. In this manner, retarders may be used to further control the speed of a cut as it travels through the marshalling tracks of the hump yard.

In embodiments, distance units that may be configured to detect how far a current location of a cut within the hump yard may be from other cuts, from other devices, and/or from other points along the cut's route. In some embodiments, distance units may be used to measure a distance. In embodiments, identification devices may be configured to detect an identification of a cut, such as via radio frequency identification (RFID) devices. Identification devices may be used to identify cuts as the cuts travel through the marshalling tracks of the hump yard.

In embodiments, the components of classification yard 140 may include occupancy devices that may include track circuits, light detectors, presence detectors, etc., and may be configured to detect occupancy of a track and/or track segment, such as to detect a presence of a vehicle within the track and/or track segment. In some embodiments, occupancy devices may be configured to detect when a track or track segment has been filled to a safe capacity, which may enable a system to prevent overfilling of the track or track segment. In embodiments, occupancy devices may be used in long sections of track that may not include a wheel detector, a retarder, etc. In embodiments, an occupancy device may be configured with predicted on and off times. If the on and off times are exceeded, a segment protected by the occupancy device may be temporarily protected and if the condition persists, the protection may remain. In embodiments, protecting a track or track segment may include routing away from the protected track or track segment, such as in response to a determination that sufficient time exists to route the vehicle away from the protected track or track segment. However, the railroad vehicle may be routed into the protected track segment (e.g., to prevent a side-swipe) in response to a determination that there is not sufficient time to route the vehicle away from the protected track or track segment.

In embodiments, the various devices in devices 142 may be positioned at different locations or points within the layout of the classification yard. In embodiments, the position of the various devices in devices 142 may be determined based on the layout of the track segments (e.g., segments 144) making up the marshalling tracks of classification yard 140. For example, a first retarder may be positioned along the release section of the hump, whereas a second retarder may be positioned along a different segment. In embodiments, wheel detectors and/or switches may be positioned at the entry point of each track segment within classification yard 140.

For example, the marshalling tracks of classification yard 140 may be divided into a plurality of segments (e.g., segments 144). In embodiments, each of segments 144 may be defined by an entry point and an exit. In some embodiments, the entry point and/or the exit point of a segment may correspond to a device (e.g., a switch, a retarder, a detector, etc.) of classification yard 140. In this manner, devices may be used to divide the marshalling tracks of classification yard 144 into segments 144. In embodiments, a route followed by a cut may be defined by a connection of various segments of segments 144 that may route the cut from the hump section to the assigned destination track. In some embodiments, a segment may include one or more devices within the segment. For example, a segment may include one or more retarders, one or more switches, one or more detectors, within the boundaries of the segment (e.g., in addition to the entry and/or exit point devices of the segment). In some embodiments, segments may be defined by geographical features.

User terminal 130 may include a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In embodiments, user terminal 130 may provide a user interface that may be configured to provide an interface (e.g., a graphical user interface (GUI)) structured to facilitate an operator interacting with system 100, e.g., via network 145, to execute and leverage the features provided by server 110. In embodiments, the operator may be enabled, e.g., through the functionality of user terminal 130, to provide configuration parameters that may be used by system 100 to provide functionality for automatic tuning of classification yard 140 operations, as well as to interact with results (e.g., selection, confirmation, verification of results, etc.). In embodiments, user terminal 130 may be configured to communicate with other components of system 100. In embodiments, the functionality of user terminal 130 may include presenting results of automatic tuning operations to an operator. In embodiments, the results of automatic tuning operations may be presented to an operator via the GIU of user terminal 130.

In embodiments, server 110, classification yard 140 (and its various components), and user terminal 130 may be communicatively coupled via network 145. Network 145 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc.

Server 110 may be configured to facilitate operations for providing predictive models for estimating tuning coefficients for automatically tuning operations of a classification yard in accordance with embodiments of the present disclosure. In embodiments, functionality of server 110 to provide predictive models for estimating tuning coefficients for automatically tuning operations of a classification yard may be provided by the cooperative operation of the various components of server 110, as will be described in more detail below.

Although FIG. 1 shows a single server 110, it will be appreciated that server 110 and its individual functional blocks may be implemented as a single device or may be distributed over multiple devices having their own processing resources, whose aggregate functionality may be configured to perform operations in accordance with the present disclosure. Furthermore, those of skill in the art would recognize that although FIG. 1 illustrates components of server 110 as single and separate blocks, each of the various components of server 110 may be a single component (e.g., a single application, server module, etc.), may be functional components of a same component, or the functionality may be distributed over multiple devices/components. In such embodiments, the functionality of each respective component may be aggregated from the functionality of multiple modules residing in a single, or in multiple devices. In addition, particular functionality described for a particular component of server 110 may actually be part of a different component of server 110, and as such, the description of the particular functionality described for the particular component of server 110 is for illustrative purposes and not limiting in any way.

As shown in FIG. 1, server 110 includes processor 111, memory 112, database 124, prediction manager 120, data compiler 121, candidate coefficient generator 122, and automatic tuning manager 123. Processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of processor 111 may comprise code segments (e.g., software, firmware, and/or hardware logic) executable in hardware, such as a processor, to perform the tasks and functions described herein. In yet other embodiments, processor 111 may be implemented as a combination of hardware and software. Processor 111 may be communicatively coupled to memory 112.

Memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 112 may comprise a processor readable medium configured to store one or more instruction sets (e.g., software, firmware, etc.) which, when executed by a processor (e.g., one or more processors of processor 111), perform tasks and functions as described herein.

Memory 112 may also be configured to facilitate storage operations. For example, memory 112 may comprise database 124 for storing various information related to operations of system 100. For example, database 124 may store predictive models, analysis models, threshold data, configuration information, etc., to be used for operations of system 100, etc. In embodiments, database 124 may store characteristics of various and different train cars, such as rolling resistance characteristics, weights, aerodynamic characteristics (e.g., drag coefficient, coupler overhang status, articulation status of the etc. In embodiments, database 124 may store event data related to speed and/or energy measurements of a cut at various segments of the marshalling tracks of classification yard 140. For example, as a cut travels along various segments of a route through the marshalling tracks of classification yard 140 to reach a destination train, speed and/or energy measurements may be taken at each segment (e.g., via one or more components of classification yard 140 such as switches 142, detectors 144, retarders 146, etc.) to generate speed and/or energy measurements associated with the cut at each of the various segments. For example, a cut may travel through a first segment of a route through the marshalling tracks of classification yard 140 to reach a destination train, and this may be considered an event. Speed and/or energy measurements may be taken at the segment, and the speed and/or energy measurements may indicate the speed and/or energy at which the cut traveled through the segment. This speed and/or energy measurements may be stored in database 124 along with an indication (e.g., identification) of the segment and the cut associated with the measurements (e.g., as an event associated with the segment and/or the cut).

In some embodiments, database 124 may store predictions related to the travelling of a cut through various segments of the marshalling tracks of classification yard 140. For example, in some embodiments, a prediction manager (e.g., prediction manager 120) may generate a prediction related to a speed and/or energy at which a cut may travel through a segment or device. In this case, the prediction related to the cut and the segment or device may be stored in database 124 along with an indication (e.g., identification) of the segment or device and the cut associated with the prediction (e.g., as a prediction associated with the segment or device, and/or the cut).

Database 124 is illustrated as integrated into memory 112, but in some embodiments, database 124 may be provided as a separate storage module or may be provided as a cloud-based storage module. Additionally, or alternatively, database 124 may be a single database, or may be a distributed database implemented over a plurality of database modules.

Prediction manager 120 may be configured to predict arrival times and/or speeds of one or more cuts at various points along a route that the one or more cuts may travel along the marshalling tracks to reach their assigned destination track/train. In embodiments, prediction manager 120 may predict arrival times and/or speeds of a cut at various points along a route for each of the front and rear of the cut.

In embodiments, the various points for which production prediction manager 120 may predict arrival times and/or speeds of a cut may include components or devices (e.g., switches, retarders, detectors, etc.) of classification yard 140, or may include an entry and/or exit point of a segment. For example, in embodiments, a route that a cut may travel from the hump release point to its assigned destination track may be divided into a plurality of segments. In this manner, a route from the hump to any destination track/train may be formed by assembling a set of segments of the marshalling tracks, and each segment may be defined by the entry and exit points of the segment. In some embodiments, the entry point and/or the exit point of a segment may correspond to a device (e.g., a switch, a retarder, a detector, etc.) of classification yard 140. In this manner, devices may be used to divide the marshalling tracks into segments.

In some embodiments, prediction manager 120 may include functionality to predict an amount of energy, or speed, that a retarder is expected to remove. For example, a cut may travel, or may be assigned to travel, along a route through the marshalling tracks to reach an assigned destination track/train that may include one or more retarders. In embodiments, prediction manager 120 may include functionality to predict the amount of energy, or speed, that the one or more retarders are expected to remove from the cut as the cut travels through the one or more retarders. In some embodiments, predicting the amount of energy, or speed, that the one or more retarders are expected to remove from the cut as the cut travels through the one or more retarders may include predicting an amount of energy, or speed, that the cut is expected to have at the entry point of the one or more retarders and an amount of energy, or speed, that the cut is expected to have at the exit point of the one or more retarders. In these cases, the difference between the entry point energy, or speed, and the exit point energy, or speed, may indicate the amount of energy, or speed, removed by the one or more retarders.

In embodiments, the functionality of prediction manager 120 to predict arrival times and/or speeds of one or more cuts at various points along the route of the cut may include various operations. For example, prediction manager 120 may determine a target coupling speed of a cut based, at least in part, on characteristics of the cut (e.g., the weight of the cut, the type of train cars in the cut, the type of freight being carried by the cut, whether the cut is a special cut (e.g., a cut having a flag indicating that the cut is to be coupled slowly), etc.), as well as track characteristics of the tracks along which the cut may travel (e.g., whether the destination track is overfilled (e.g., past a clearance point), the type of track, the layout of the destination track, characteristics of the previous cut routed through the marshalling tracks (e.g., the weight of the previous cut, the type of freight being carried by the previous cut, a status of the previous cut, special handling instructions for the previous cut (e.g., the previous cut having a flag indicating that the previous cut is to be given a large clearance between cuts), etc.).

Prediction manager 120 may then calculate an energy delta (e.g., amount of energy gained or lost) at each point (e.g., segment or device) of the route along which the cut may travel to reach the coupling point at the target coupling speed. For example, with respect to a first segment along the route of the cut, prediction manager 120 may calculate the amount of energy (e.g., amount of energy or speed) gained or lost by the cut at the first segment. In embodiments, the energy gained or lost by a cut at a segment may include the energy needed by the cut at the entry point of the segment to reach the exit point of the segment at a desired speed. In some cases, the energy needed by the cut to traverse the segment may be a negative value, which may indicate that the cut may have excess energy in the segment that may need to be removed (e.g., by a retarder) in order to ensure that the cut may reach the exit point of the segment at the desired speed. In some cases, the energy needed by the cut to traverse the segment may be a positive value, which may indicate that the cut may lose energy while traversing the segment.

Prediction manager 120 may calculate the amount of energy (e.g., amount of energy or speed) gained or lost by the cut at a segment or device using one or more tuning coefficients that may be defined for the segment or device. In embodiments, the calculation of the amount of energy gained or lost by the cut at the segment or device may include applying an equation that includes the one or more tuning coefficients. In embodiments, the tuning coefficients may include coefficients related to rolling resistance, such as B₀ (e.g., rolling resistance loss coefficient), B₁ (e.g., rolling resistance loss first order coefficient, which may be related to energy loss due to rolling resistance for all cuts traveling through the segment or device), B₂ (e.g., rolling resistance loss second order coefficient, which may be related to energy loss due to rolling resistance for the particular cut as it travels through the segment or device), B₃ (e.g., rolling resistance loss third order coefficient), etc. In some embodiments, the tuning coefficients may include coefficients related to the effects on rolling resistance due to temperature, such as W₀, W₁, W₂, and W₃, coefficients related to angles (e.g., angle coefficients associated with the cut traveling a long a curve), etc.

In embodiments, an initial set of tuning coefficients for a segment or device may be generated (or calculated) prior to classification operations, and may be stored in database 124 to be used during classification operations of classification yard 140. For example, the initial set of tuning coefficients for a segment may be generated by collecting data for a plurality of car events associated with the segment and analyzing the data to obtain a set of rolling resistance tuning coefficients. For example, different cuts having different characteristics (e.g., rolling resistance, weight, length, etc.) may be run through the segment generating a plurality of car events associated with the segment, including the total energy needed by the various cuts to traverse the segment (e.g., the energy change through the segment). A best fit line may be applied to the set of car events and equation of the best fit line may be used to obtain rolling resistance tuning coefficients for the segment. In this case, the y-intercept of the line equation may be used as B₀ and the slope of the line may be used as B₁. In this manner, the set of tuning coefficients for a segment may serve to tune the segment to the conditions of the segment. However, as described above, the initial set of tuning coefficients for the segment may be applicable to the conditions of the segment when the initial set of tuning coefficients was generated. As conditions of the segment change, the initial set of tuning coefficients may no longer accurately represent the energy delta of various cuts passing through the segment. Nonetheless, features of the present disclosure, as described herein, provide a mechanism to automatically adapt the tuning of a segment to changing conditions.

In embodiments, prediction manager 120 may also determine a maximum amount of energy removeable by retarders throughout the route of the segment. Prediction manager 120 may then determine a release speed, and may determine a total energy needed to be removed by the retarders throughout the route in order to reach the coupling point at the target coupling speed. In embodiments, prediction manager 120 may predict arrival times and/or speeds of the cut at each of a plurality of points throughout the route of cut. For example, prediction manager 120 may predict arrival times and/or speeds of the cut at each segment (e.g., arrival time and/or speed at the entry point and/or exit point of one or more segments of the route) and/or arrival times and/or speeds of the cut at each of one or more devices in the route. In embodiments, prediction manager 120 may predict an amount of energy to be removed at one or more segments of the route. In embodiments, prediction manager 120 may predict arrival times and/or speeds of the cut at each of a plurality of points throughout the route of cut by calculating the arrival time and/or speed of the cut at each of the plurality of points based on the energy calculations and energy removal calculations performed for each of the plurality of points.

In embodiments, the predictions generated by prediction manager 120 associated with each point (e.g., segment or device) along the route of a cut may be stored in a database (e.g., database 124). It is noted that these predictions may represent predictions made using a current set of tuning coefficients associated with each device and/or segment.

In embodiments, as the various cuts travel along their respective routes, at each point (e.g., at each device and at each segment) along the route, for each cut, real-world measurements associated with the actual speed and/or energy of each cut may be captured. For example, as a cut passes through a retarder, actual speed and/or energy measurements may be taken at the entry point and/or exit points of the retarder. These measurements may indicate the speed at which the cut entered the retarder and the speed at which the cut exited the retarder, which may indicate the amount of energy or speed that the retarder removed from the cut as the cut passed through the retarder. In embodiments, the same process may be performed to measure the speed of the cut as it passes through a detector or a switch. In another example, as the cut passes through a segment, actual speed and/or energy measurements may be taken at the entry point and/or exit point of the segment (e.g., using a detector, such as a detector at each of the entry point and/or exit point of the segment). These measurements may indicate the speed at which the cut entered the segment and the speed at which the cut exited the segment, which may indicate the amount of energy or speed removed or gained by or from the cut as the cut passed through the segment.

In embodiments, the captured data may be stored in a database (e.g., database 124). For example, the captured data may be formatted as car events and may be stored in the database as car event data. In embodiments, each car event may represent a cut passing through a device and/or segment. In embodiments, each car event (e.g., each data point of the car event data) may include information associated with the car event, such as a segment identification, a cut identification, an actual entry speed of the cut, an actual exit speed of the cut, a timestamp of the entry of the cut, a timestamp of the exit of the cut from the segment, an indication of a wheel of the cut that was detected, weather conditions at the time the data was captured, etc. In some embodiments, a car event may also include a prediction associated with the car event. For example, prediction manager 120 may generate a prediction regarding the arrival time and/or speed of a cut across a particular segment. In embodiments, the car event data corresponding to the car event of the cut passing the particular segment may include the prediction generated by prediction manager 120.

In embodiments, data compiler 121 may be configured to compile data related to car events and to filter the data according to various configuration parameters. In embodiments, data compiler 121 may provide a robust mechanism for configuring, controlling, and executing data retrieval and compilation functionality in order to obtain a most appropriate set of car events and leverage the car event data for automatic tuning of parameters. For example, in embodiments, data compiler 121 may be configured to retrieve and compile the car event data by configuring and scheduling one or more analysis jobs that include configuration associated with the analysis job itself as well as the car event data against which analysis is to be performed. Techniques for retrieving and compiling car event data by configuring and scheduling one or more analysis jobs are described in pending and co-owned U.S. Patent Application Docket No. BNSF-00163, the entirety of which is herein incorporated by reference for all purposes.

In embodiments, data compiler 121 may be configured to retrieve car events (e.g., from database 124) and may filter the car events (e.g., based on a device or segment for which car events are to be compiled (e.g., an identification of the device or segment), a minimum car event count (e.g., a minimum number of switch throws, etc.), a type of precipitation associated with the car events, such as the precipitation status when the car event was recorded (e.g., dry, wet, rain, snow, rust, all), a maximum temperature at the time of the car event, a minimum temperature at the time of the car event, an indication of a time period that each task performing the analysis job may be available after completion, etc.). The result of the filtering may include a set of car events, where each car event may represent a cut passing through a device and/or segment, and may include information related to the speed or energy of the cut while passing through the device and/or segment, such as actual speed measurements and/or predicted speed measurements.

Candidate coefficient generator 122 may be configured to generate a candidate set of tuning coefficients for each of the segments and/or devices represented in the compiled set of car events compiled by data compiler 121. In embodiments, candidate coefficient generator 122 may be configured to estimate candidate coefficients for each of the segments and/or devices based on one or more predictive models applied against the real-world measurements included in car events associated with each of the segments and/or devices. For example, for a first segment represented in the compiled set of car events, candidate coefficient generator 122 may be configured to apply one or more predictive models to the real-world measurements captured for each car event associated with the first segment to estimate one or more candidate tuning coefficients. In embodiments, the candidate tuning coefficients for a segment may represent an “after-the-fact” calculation of what the tuning coefficients for the segment “should have been” based on the real-world results at the segment, regardless of what the actual set of tuning coefficients (e.g., the current set of tuning coefficients) for the segment is. Ideally, where the conditions of the segment remain perfectly constant, never changing, the current set of tuning coefficients and the candidate set of tuning coefficients would be the same, as the predictions made using the current set of tuning coefficients would likely be perfect, and the candidate set of tuning coefficients estimated using the real-world measurements would be the same. However, as in real-life, the conditions of the segment do not remain constant and are ever-changing, the candidate set of tuning coefficients and the current set of tuning coefficients may likely be different. Embodiments of the present disclosure provide mechanisms to determine which of the candidate set of tuning coefficients and the current set of tuning coefficients yields more accurate results, as will be described in more detail below.

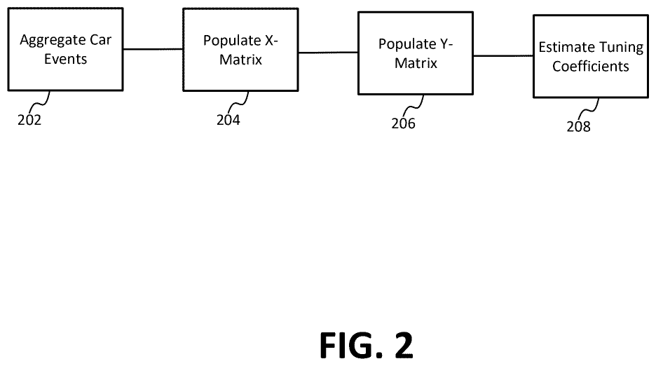

In embodiments, the predictive models that may be applied by candidate coefficient generator 122 to the compiled set of car events to generate a candidate set of tuning coefficients for each of the segments and/or devices represented in the compiled set of car events may include a set of linear regression models. FIG. 2 is a block diagram illustrating an example of application of a set of linear regression models to estimate a candidate set of tuning coefficients in accordance with the embodiments of the present disclosure.

At block 202, car events are aggregated. For example, in embodiments, car events associated with each segment or device may be aggregated into a respective aggregated set of car events. In these embodiments, an aggregated set of car events may be generated for each segment and/or device represented in the compiled set of car events.

At block 204, an X-matrix is populated. In embodiments, an X-matrix may be populated for each segment or device represented in the compiled set of car events. In embodiments, the X-matrix may be populated using the results of a coefficient formula for each tuning coefficient in the regression model, for each car event in the aggregated set of car events associated with the segment or device for which the X-matrix is being populated. For example, for estimating rolling resistance coefficients (e.g., which may be used to predict energy losses or gains at a segment due to friction), the X-matrix may be populated with the results of a coefficient formula for each rolling resistance coefficient. For example, for estimating the B₀ and B₁ rolling resistance coefficients for a segment, a coefficient formula may be applied to each car event in the aggregated set of car events associated with the segment (e.g., B₁=rolling resistance measured*segment distance*cut weight). The results of the coefficient formula may include a value for each car event, and the value for each car event may be used as an entry to populate the X-matrix. In another example, the regression model may include the B₀, B₁, and B₂ rolling resistance coefficients. In this example, when estimating the B₀, B₁, and B₂ rolling resistance coefficients for a segment, each entry of the X-matrix may be populated with a double-entry array. Each of the double-entry arrays may be associated with a car event and may include the results of the B₁ coefficient formula, as described above and the results of a coefficient formula for obtaining a B₂ value (e.g., B₂=rolling resistance measured²*segment distance*cut weight). In each example above, the X-matrix for a segment may include a number of entries equal to the number of car events in the aggregated set of car events associated with the segment (e.g., one matrix entry for each car event associated with the segment).

At block 206, a Y-matrix is populated. In embodiments, a Y-matrix may be populated for each segment or device represented in the compiled set of car events. In embodiments, the Y-matrix may be populated using the results of an equation applied against the real-world results in the car events using the tuning coefficients. For example, the regression model may include the rolling resistance coefficients that may be used to calculate or predict the frictional energy at a segment (e.g., rolling resistance coefficients that may be used to predict energy losses or gains at the segment due to friction). In this example, the frictional energy equation (e.g., a line equation using the rolling resistance coefficients) may be applied to each car event in the aggregated set of car events associated with the segment or device for which the Y-matrix is being populated. The results of the frictional energy equation for each car event may be used as an entry of the Y-matrix, where each entry of the Y-matrix includes a frictional energy value obtained from the frictional energy equation applied against a car event of the aggregated set of car events associated with the segment or device for which the Y-matrix is being populated.

At block 208, a candidate set of tuning coefficients is generated for each segment or device represented in the compiled set of car events based on respective X-matrix and Y-matrix. For example, candidate tuning coefficients may be estimated for a first segment or device based on the X-matrix and Y-matrix generated for the first segment or device. In embodiments, linear regression operations (e.g., ordinary least squares multiple linear regression, etc.) may be applied against the X-matrix and Y-matrix of the first segment or device to estimate the tuning coefficients defined in the regression model. The results of the linear regression operations may include an array of values, where the values represent an estimate of the tuning coefficients in the regression model for the first segment or device. In this manner, the results of the linear regression operations applied to the X-matrix and Y-matrix for each segment or device represented in the compiled set of car events may include an array of values for each segment or device, where each array of values includes an estimate of the tuning coefficients for a respective segment or device.

For example, the regression model may include the rolling resistance coefficients. In this example, the linear regression operations may be applied against the X-matrix and Y-matrix generated for the first segment or device, and the results may include an array of values, where each value in the array of values represent an estimated tuning coefficients in accordance with the regression model. For example, the regression model may include the B₀ and B₁ rolling resistance coefficients. In this example, the results of the linear regression operations applied against the X-matrix and Y-matrix generated for a first segment or device may include an array of values that includes estimated B₀ and B₁ rolling resistance coefficients for the first segment or device. In another example, the regression model may include the B₀, B₁, and B₂ rolling resistance coefficients. In this example, the results of the linear regression operations applied against the X-matrix and Y-matrix generated for the first segment or device may include an array of values that includes estimated B₀, B₁, and B₂ rolling resistance coefficients for the first segment or device.

It is noted that although the present disclosure describes predictive models for estimating tuning coefficients that include linear regression models, this is for illustrative purposes and not by way of limitation. Indeed, in some embodiments, other predictive algorithms, such as other regression or machine learning models, may be used to estimate tuning coefficients for a segment or device in a classification yard. As such, the description of linear regression models herein should not be construed as limiting in any way.

With reference back to FIG. 1, automatic tuning manager 123 may be configured to validate the candidate set of tuning coefficients for each of the segments and/or devices generated by candidate coefficient generator 122 and to automatically tune each of the segments and/or devices based on the validation of the candidate set of tuning coefficients. In embodiments, the validation of the candidate set of tuning coefficients may include comparing the candidate set of tuning coefficients with the current set of tuning coefficients to determine whether predictions made using the candidate set of tuning coefficients are more accurate than predictions made using the current set of tuning coefficients or not.

In embodiments, automatic tuning manager 123 may generate a set of candidate predictions based on the candidate set of tuning coefficients for each of the segments and/or devices generated by candidate coefficient generator 122 and the compiled set of car events. For example, automatic tuning manager 123 may generate a set of candidate predictions for a first segment (e.g., arrival times and/or speeds of cuts passing through the first segment) based on the candidate tuning coefficients for the first segment, where each candidate prediction may correspond to a car event in the compiled set of car events to which the first segment may be associated. Each candidate prediction may be based on the candidate tuning coefficients and the data included in each respective car event (e.g., cut characteristics, prevailing conditions, etc.). It is noted that the candidate predictions generated by automatic tuning manager 123 may represent an after-the-fact prediction, in that the predicted arrival times and/or speeds of a cut at a particular device or segment may be made by automatic tuning manager 123 based on car events that have already occurred at the particular segment or device. In this manner, the candidate predictions associated with a car event are made after the car event has already happened. In this manner, the candidate predictions of a car event differ from the production predictions of the car event generated by prediction manager 120 in that the production predictions are generated before the event occurs and using current tuning coefficients and the candidate predictions generated by automatic tuning manager 123 are generated after the event occurs and are made using candidate tuning coefficients calculated from real-world data associated with the car events.

In embodiments, automatic tuning manager 123 may be configured to compare the production predictions generated by prediction manager 120 and the candidate predictions generated by automatic tuning manager 123, to determine which of the current set of tuning coefficients and the candidate set of tuning coefficients provides a more accurate prediction of speeds and/or arrival times of a cut at a segment or device, and to deploy the tuning coefficients that yield more accurate predictions to the production environment of the segment or device. In this manner, automatic tuning manager 123 may be configured to automatically tune classification yard 140 by automatically tuning the tuning coefficients of each segment or device of classification yard 140.

In embodiments, functionality of automatic tuning manager 123 to compare the production predictions and the candidate predictions may include comparing the production predictions and the candidate predictions related to a car event (e.g., speed and/or arrival times of a cut at a particular segment or device) with the real-world measurements related to the car event, to determine whether the production predictions or the candidate predictions more accurately reflect the real-world measurements.

In embodiments, automatic tuning manager 123 may employ an absolute deviation analysis for comparing the production predictions and the candidate predictions related to a car event with the real-world measurements related to the car event. For example, automatic tuning manager 123 may, for each car event associated with a segment or device, measure an absolute value deviation between a predicted value and the real-world measured value for each car event, and may then average the absolute value deviations over all the car events associated with the segment or device to obtain an absolute value average difference for the segment or device, which may represent an absolute value average difference of the predictions for all car events associated with the segment or device.

For example, automatic tuning manager 123 may, for each production prediction associated with a car event, obtain an absolute difference between the predicted values (e.g., production predicted speed and/or arrival time of the corresponding cut at the corresponding device or segment associated with each car event) and the real-world measurements related to the car event (e.g., actual speed and/or arrival time of the corresponding cut at the corresponding device or segment). In embodiments, automatic tuning manager 123 may average, for each segment or device, the absolute difference for all car events associated with the segment or device into a production absolute value average difference for the segment or device. The result may include a production absolute value average difference associated with the segment or device.

In embodiments, automatic tuning manager 123 may, for each candidate prediction associated with a car, obtain an absolute difference between the predicted values (e.g., candidate predicted speed and/or arrival time of the corresponding cut at the corresponding device or segment associated with each car event) and the real-world measurements related to the car event (e.g., actual speed and/or arrival time of the corresponding cut at the corresponding device or segment). In embodiments, automatic tuning manager 123 may average, for each segment or device, the absolute difference for all car events associated with the segment or device into a candidate absolute value average difference for the segment or device. The result may include a candidate absolute value average difference associated with the segment or device.

Automatic tuning manager 123 may be configured to determine to replace the current set of tuning coefficients for a segment or device with a candidate set of tuning coefficients in response to a determination that the candidate set of tuning coefficients yields more accurate predictions for car events at the segment or device than the current set of tuning coefficients. For example, in embodiments, automatic tuning manager 123 may compare the production absolute value average difference to the candidate absolute value average difference for a first segment or device, and may determine to either replace the current set of tuning coefficients with the candidate set of tuning coefficients or to reject the candidate set of tuning coefficients and continue using the current set of tuning coefficients based on which of the current set of tuning coefficients and the candidate set of tuning coefficients provides a more accurate prediction with respect to real-world measurements. For example, automatic tuning manager 123 may determine to continue using the current production set of tuning coefficients for a segment or device in operations of classification yard 140 (e.g., operations to calculate and/or predict speed, energy, and/or arrival times at the first segment or device) and to reject the candidate set of tuning coefficients in response to a determination that the current production set of tuning coefficients provides a more accurate prediction of car events at the segment or device than the candidate set of tuning coefficients (e.g., in response to a determination that the production absolute value average difference is not larger than the candidate absolute value average difference). On the other hand, automatic tuning manager 123 may determine to replace the current production set of tuning coefficients for the segment or device with the candidate set of tuning coefficients in response to a determination that the candidate set of tuning coefficients provides a more accurate prediction of car events at the segment or device than the current production set of tuning coefficients (e.g., in response to a determination that the candidate absolute value average difference is larger than the production absolute value average difference).

In embodiments, a similar process may be performed for the other segments and/or devices represented in the set of car events to determine whether the current production set of tuning coefficients may continue to be used or whether the candidate set of tuning coefficients may be deployed to replace the current production set of tuning coefficients.

In embodiments, continuing to use the current production set of tuning coefficients or deploying the candidate set of tuning coefficients to replace the current production set of control parameters for a segment or device may be performed automatically by automatic tuning manager 123. In these embodiments, automatic tuning manager 123 may either replace the current production set of tuning coefficients for a segment or device in a database (e.g., database 124) with the candidate set of tuning coefficients (e.g., when deploying the candidate set of tuning coefficients), or may leave the current production set of tuning coefficients for the segment or device in the database.

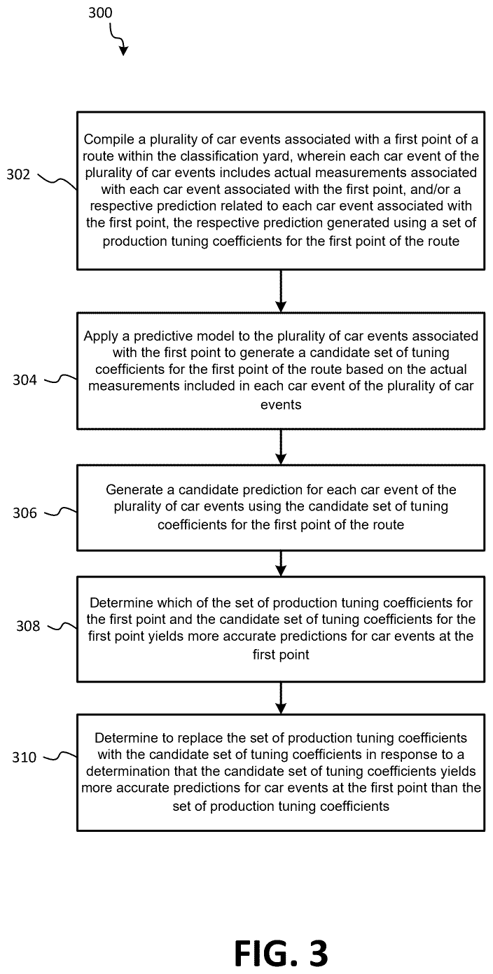

FIG. 3 shows a high-level flow diagram 300 of operation of a system configured in accordance with embodiments of the present disclosure for providing predictive models for estimating tuning coefficients for automatically tuning operations of a classification yard. For example, the functions illustrated in the example blocks shown in FIG. 3 may be performed by system 100 of FIG. 1 according to embodiments herein. In embodiments, the operations of the method 300 may be stored as instructions that, when executed by one or more processors, cause the one or more processors to perform the operations of the method 300.

At block 302, a plurality of car events associated with a first point of a route within the classification yard is compiled. In embodiments, each car event of the plurality of car events may include actual measurements associated with each car event associated with the first point and/or a respective prediction related to each car event associated with the first point. In embodiments, the respective prediction may be generated using a set of production tuning coefficients for the first point of the route. In embodiments, functionality of a data compiler (e.g., data compiler 121 in FIG. 1) may be used to compile a plurality of car events associated with a first point of a route within the classification yard. In embodiments, the data compiler may perform operations to compile a plurality of car events associated with a first point of a route within the classification yard according to operations and functionality as described above with reference to data compiler 121 and as illustrated in FIGS. 1-2.

At block 304, a predictive model is applied to the plurality of car events associated with the first point to generate a candidate set of tuning coefficients for the first point of the route based on the actual measurements included in each car event of the plurality of car events. In embodiments, functionality of a candidate coefficients generator (e.g., candidate coefficients generator 122 in FIG. 1) may be used to apply a predictive model to the plurality of car events associated with the first point to generate a candidate set of tuning coefficients for the first point of the route based on the actual measurements included in each car event of the plurality of car events. In embodiments, the candidate coefficients generator may perform operations to apply a predictive model to the plurality of car events associated with the first point to generate a candidate set of tuning coefficients for the first point of the route based on the actual measurements included in each car event of the plurality of car events according to operations and functionality as described above with reference to candidate coefficients generator 122 and as illustrated in FIGS. 1-2.

At block 306, a candidate prediction for each car event of the plurality of car events is generated using the candidate set of tuning coefficients for the first point of the route. In embodiments, functionality of an automatic tuning manager (e.g., automatic tuning manager 123 in FIG. 1) may be used to generate a candidate prediction for each car event of the plurality of car events using the candidate set of tuning coefficients for the first point of the route. In embodiments, the automatic tuning manager may perform operations to generate a candidate prediction for each car event of the plurality of car events using the candidate set of tuning coefficients for the first point of the route according to operations and functionality as described above with reference to automatic tuning manager 123 and as illustrated in FIGS. 1-2.

At block 308, a determination is made as which of the set of production tuning coefficients for the first point and the candidate set of tuning coefficients for the first point yields more accurate predictions for car events at the first point. In embodiments, functionality of an automatic tuning manager (e.g., automatic tuning manager 123 in FIG. 1) may be used to determine which of the set of production tuning coefficients for the first point and the candidate set of tuning coefficients for the first point yields more accurate predictions for car events at the first point. In embodiments, the automatic tuning manager may perform operations to determine which of the set of production tuning coefficients for the first point and the candidate set of tuning coefficients for the first point yields more accurate predictions for car events at the first point according to operations and functionality as described above with reference to automatic tuning manager 123 and as illustrated in FIGS. 1-2.

At block 310, a determination is made to replace the set of production tuning coefficients with the candidate set of tuning coefficients in response to a determination that the candidate set of tuning coefficients yields more accurate predictions for car events at the first point than the set of production tuning coefficients. In embodiments, functionality of an automatic tuning manager (e.g., automatic tuning manager 123 in FIG. 1) may be used to determine to replace the set of production tuning coefficients with the candidate set of tuning coefficients in response to a determination that the candidate set of tuning coefficients yields more accurate predictions for car events at the first point than the set of production tuning coefficients. In embodiments, the automatic tuning manager may perform operations to determine to replace the set of production tuning coefficients with the candidate set of tuning coefficients in response to a determination that the candidate set of tuning coefficients yields more accurate predictions for car events at the first point than the set of production tuning coefficients according to operations and functionality as described above with reference to automatic tuning manager 123 and as illustrated in FIGS. 1-2.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in FIGS. 1-6 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of estimating tuning coefficients for automatic tuning of operations of a classification yard, comprising:
compiling a plurality of car events associated with a first point of a route within the classification yard, wherein each car event of the plurality of car events includes one or more of:
actual measurements associated with each car event associated with the first point; and
a respective prediction related to each car event associated with the first point, the respective prediction generated using a set of production tuning coefficients for the first point of the route;
applying a predictive model to the plurality of car events associated with the first point to generate a candidate set of tuning coefficients for the first point of the route based on the actual measurements included in each car event of the plurality of car events;
generating a candidate prediction for each car event of the plurality of car events using the candidate set of tuning coefficients for the first point of the route;
determining which of the set of production tuning coefficients for the first point and the candidate set of tuning coefficients for the first point yields more accurate predictions for car events at the first point; and
determining to replace the set of production tuning coefficients with the candidate set of tuning coefficients in response to a determination that the candidate set of tuning coefficients yields more accurate predictions for car events at the first point than the set of production tuning coefficients.

2. The method of claim 1, wherein applying the predictive model to the plurality of car events associated with the first point to generate the candidate set of tuning coefficients for the first point of the route includes:
populating a first matrix with results of a coefficient formula for each tuning coefficient in the predictive model applied to each car event in the plurality of car events associated with the first point;
populating a second matrix with results of an equation applied to the actual measurements include in each car event of the plurality of car events using each tuning coefficient in the predictive model; and
applying a linear regression analysis against the first matrix and the second matrix to generate an estimate for each tuning coefficient in the predictive model.

3. The method of claim 2, wherein each entry of the first matrix corresponds to a car event of the plurality of car events.

4. The method of claim 2, wherein the predictive model includes one or more of:
rolling resistance coefficients;
temperature coefficients;
regression coefficients;
switch coefficients;
retarder coefficients;
detector coefficients; and
angle coefficients.

5. The method of claim 4, wherein the predictive model includes rolling resistance coefficients including one or more of:
a B₀ rolling resistance loss coefficient;
a B₁ rolling resistance loss first order coefficient;
a B₂ rolling resistance loss second order coefficient; and
a B₃ rolling resistance loss third order coefficient.

6. The method of claim 5, wherein the predictive model includes the B₀ rolling resistance loss coefficient and the B₁ rolling resistance loss first order coefficient, and wherein each entry of the first matrix includes a single value corresponding to the B₁ rolling resistance loss first order coefficient calculated for a respective car event of the plurality of car events.

7. The method of claim 5, wherein the predictive model includes the B₀ rolling resistance loss coefficient, the B₁ rolling resistance loss first order coefficient, and the B₂ rolling resistance loss second order coefficient, and wherein each entry of the first matrix includes a double-value corresponding to both the B₁ rolling resistance loss first order coefficient calculated for a respective car event of the plurality of car events and the B₂ rolling resistance loss second order coefficient calculated for the respective car event of the plurality of car events.

8. The method of claim 2, wherein the estimate for each tuning coefficient in the predictive model includes a set of coefficient values, each coefficient value of the set of coefficient values corresponding to a tuning coefficient in the predictive model.

9. The method of claim 1, wherein the first point of the route includes one or more of a route segment and a device of the classification yard.

10. The method of claim 1, wherein the set of production tuning coefficients for the first point of the route includes one or more of:
rolling resistance coefficients;
temperature coefficients;
regression coefficients;
switch coefficients;
retarder coefficients;
detector coefficients; and
angle coefficients.

11. The method of claim 1, wherein determining which of the set of production tuning coefficients for the first point and the candidate set of tuning coefficients for the first point yields more accurate predictions for car events at the first point includes:
calculating a production absolute value average difference between each respective prediction related to each car event associated with the first point and the actual measurements associated with each car event associated with the first point;
calculating a candidate absolute value average difference between the candidate prediction for each car event and the actual measurements associated with each car event associated with the first point;
comparing the production absolute value average difference and the candidate absolute value average difference to determine which one of the production absolute value average difference and the backoffice absolute value average difference is smaller;
determining that the set of production tuning coefficients yields more accurate predictions for car events at the first point of the route than the candidate set of tuning coefficients in response to a determination that the production absolute value average difference is smaller than the backoffice absolute value average difference for the first point of the route; and
determining that the candidate set of tuning coefficients yields more accurate predictions for car events at the first point of the route than the set of production tuning coefficients in response to a determination that the production absolute value average difference is not smaller than the backoffice absolute value average difference for the first point of the route.

12. A system for estimating tuning coefficients for automatic tuning of operations of a classification yard, comprising:
at least one processor; and
a memory operably coupled to the at least one processor and storing processor-readable code that, when executed by the at least one processor, is configured to perform operations including:
compiling a plurality of car events associated with a first point of a route within the classification yard, wherein each car event of the plurality of car events includes one or more of:
actual measurements associated with each car event associated with the first point; and
a respective prediction related to each car event associated with the first point, the respective prediction generated using a set of production tuning coefficients for the first point of the route;
applying a predictive model to the plurality of car events associated with the first point to generate a candidate set of tuning coefficients for the first point of the route based on the actual measurements included in each car event of the plurality of car events;
generating a candidate prediction for each car event of the plurality of car events using the candidate set of tuning coefficients for the first point of the route;
determining which of the set of production tuning coefficients for the first point and the candidate set of tuning coefficients for the first point yields more accurate predictions for car events at the first point; and
determining to replace the set of production tuning coefficients with the candidate set of tuning coefficients in response to a determination that the candidate set of tuning coefficients yields more accurate predictions for car events at the first point than the set of production tuning coefficients.

13. The system of claim 12, wherein applying the predictive model to the plurality of car events associated with the first point to generate the candidate set of tuning coefficients for the first point of the route includes:
populating a first matrix with results of a coefficient formula for each tuning coefficient in the predictive model applied to each car event in the plurality of car events associated with the first point;
populating a second matrix with results of an equation applied to the actual measurements include in each car event of the plurality of car events using each tuning coefficient in the predictive model; and
applying a linear regression analysis against the first matrix and the second matrix to generate an estimate for each tuning coefficient in the predictive model.

14. The system of claim 13, wherein each entry of the first matrix corresponds to a car event of the plurality of car events.

15. The system of claim 13, wherein the predictive model includes one or more of:
rolling resistance coefficients;
temperature coefficients;
regression coefficients;
switch coefficients;
retarder coefficients;
detector coefficients; and
angle coefficients.

16. The system of claim 15, wherein the predictive model includes rolling resistance coefficients including one or more of:
a B₀ rolling resistance loss coefficient;
a B₁ rolling resistance loss first order coefficient;
a B₂ rolling resistance loss second order coefficient; and
a B₃ rolling resistance loss third order coefficient.

17. The system of claim 16, wherein the predictive model includes the B₀ rolling resistance loss coefficient and the B₁ rolling resistance loss first order coefficient, and wherein each entry of the first matrix includes a single value corresponding to the B₁ rolling resistance loss first order coefficient calculated for a respective car event of the plurality of car events.

18. The method of claim 16, wherein the predictive model includes the B₀ rolling resistance loss coefficient, the B₁ rolling resistance loss first order coefficient, and the B₂ rolling resistance loss second order coefficient, and wherein each entry of the first matrix includes a double-value corresponding to both the B₁ rolling resistance loss first order coefficient calculated for a respective car event of the plurality of car events and the B₂ rolling resistance loss second order coefficient calculated for the respective car event of the plurality of car events.

19. The system of claim 12, wherein determining which of the set of production tuning coefficients for the first point and the candidate set of tuning coefficients for the first point yields more accurate predictions for car events at the first point includes:
calculating a production absolute value average difference between each respective prediction related to each car event associated with the first point and the actual measurements associated with each car event associated with the first point;
calculating a candidate absolute value average difference between the candidate prediction for each car event and the actual measurements associated with each car event associated with the first point;
comparing the production absolute value average difference and the candidate absolute value average difference to determine which one of the production absolute value average difference and the backoffice absolute value average difference is smaller;
determining that the set of production tuning coefficients yields more accurate predictions for car events at the first point of the route than the candidate set of tuning coefficients in response to a determination that the production absolute value average difference is smaller than the backoffice absolute value average difference for the first point of the route; and
determining that the candidate set of tuning coefficients yields more accurate predictions for car events at the first point of the route than the set of production tuning coefficients in response to a determination that the production absolute value average difference is not smaller than the backoffice absolute value average difference for the first point of the route.

20. A computer-based tool for estimating tuning coefficients for automatic tuning of operations of a classification yard, the computer-based tool including non-transitory computer readable media having stored thereon computer code which, when executed by a processor, causes a computing device to perform operations comprising:
compiling a plurality of car events associated with a first point of a route within the classification yard, wherein each car event of the plurality of car events includes one or more of:
actual measurements associated with each car event associated with the first point; and
a respective prediction related to each car event associated with the first point, the respective prediction generated using a set of production tuning coefficients for the first point of the route;
applying a predictive model to the plurality of car events associated with the first point to generate a candidate set of tuning coefficients for the first point of the route based on the actual measurements included in each car event of the plurality of car events;
generating a candidate prediction for each car event of the plurality of car events using the candidate set of tuning coefficients for the first point of the route;
determining which of the set of production tuning coefficients for the first point and the candidate set of tuning coefficients for the first point yields more accurate predictions for car events at the first point; and
determining to replace the set of production tuning coefficients with the candidate set of tuning coefficients in response to a determination that the candidate set of tuning coefficients yields more accurate predictions for car events at the first point than the set of production tuning coefficients.
